(19) United States
(12) Patent Application Publication
(10) Pub. No.: US 2014/0095276 A1
(43) Pub. Date: Apr. 3, 2014

(54) METHOD AND SYSTEM FOR OFFERING COMBINATIONS OF GOODS AND SERVICES FOR PURCHASE AND CONTROLLING EXPENSES

(71) Applicant: Order Inn, Inc., Las Vegas, NV (US)

(72) Inventor: Eric Sutcliffe, Las Vegas, NV (US)

(21) Appl. No.: 14/037,843

(22) Filed: Sep. 26, 2013

Related U.S. Application Data
(60) Provisional application No. 61/723,831, filed on Nov. 8, 2012.
(60) Provisional application No. 61/706,909, filed on Sep. 28, 2012.

(51) Int. Cl. G06Q 20/38

(52) U.S. Cl. CPC G06Q 20/387
USPC 705/14.1

(57) ABSTRACT

A method and system are provided for bundling primary goods or services offered by a first entity with secondary goods or services offered by a second entity. Using the system, lodging services (such as in the form of a lodging reservation) may be bundled with food (such as food or meal vouchers), whereby a customer may make a single reservation that includes a room reservation from a lodging provider and a food/meal voucher associated with a food services provider, such as for a single price. A method and system are also provided for issuing and redeeming value vouchers, such as upon presentation of a voucher by a customer to a food vendor.

### RELATED APPLICATION DATA

This application claims priority to U.S. Provisional Patent Application Ser. No. 61/723,831, filed Nov. 8, 2012, and U.S. Provisional Patent Application Ser. No. 61/706,909, filed Sep. 28, 2012.

### FIELD OF THE INVENTION

The present invention relates to methods of offering, obtaining and paying for goods and services.

### BACKGROUND OF THE INVENTION

Various problems exist with current systems of linking providers of goods and services with those who wish to obtain them, as well as the systems and methods by which payment may be provided for the good and services.

One problem that exists is that customers often wish to obtain two or more goods or services but individual businesses or suppliers only offer one of the goods or services, thus forcing the customer to seek two different suppliers for the two different goods or services. This can be time consuming and often results in the customer paying a higher amount for the goods and services than if they might have been available from a single source. For example, there are a number of drawbacks associated with the goods and services offered by existing lodging providers (such as hotels and motels). First, not all lodging providers are capable of offering related secondary services such as food services. Second, existing lodging reservation systems have limited functionality.

Due to the functionality of the Internet, most lodging providers such as hotels and hotel chains now operate on-line customer reservation systems that permit a customer to check room availability and reserve one or more rooms. Common lodging customer reservation systems generally comprise at least one lodging reservation server which is configured to display one or more web pages to customers who access a website supported by the server. The customer reservation system includes a database of available rooms, room rates, room reservation dates and related data. For example, a hotel may have a single presidential suite. The database may thus contain data relating to the presidential suite, including what days it is available, what days it is reserved and the rates for particular days (for example, the rates for weekends may be higher than for weekdays).

In operation, the customer utilizes a web-enabled computing device (such as a desktop or laptop computer or a tablet, PDA or the like) to access the lodging provider's website. The customer reservation server sends back information to the customer which causes a web page to be displayed on the user's device. This web page may include graphical information which allows a user to input information, such as a desired room type and desired room reservation dates. Upon input of such information, the customer reservation system determines the availability of rooms and presents information about available rooms (if any), rates, etc.

The customer may then reserve one or more rooms, such as by inputting required reservation information and payment information. The reservation information is maintained by the customer reservation system and upon completing the reservation, the room database is updated to reflect the status of the room as reserved for the indicated dates (to thus remove the room as available to other customers).

While such electronic reservation systems have greatly simplified the room reservation process (such as, for example, compared to old systems in which reservations were maintained in a log book and a customer had to call a hotel reservation clerk in order to place a reservation), such systems have a number of drawbacks. One drawback is that such systems are specifically designed to only implement room reservations, while a particular hotel may offer a number of other goods and services.

Another problem that existing lodging providers encounter is offering a full range of lodging-related services. For example, many hotels and motels do not have an associated restaurant. However, guests often do not have transportation so that they can travel to an off-site restaurant, may not have an expense account to pay for the food (in the case of guests who are traveling for work) or may find it undesirable to attempt to locate a suitable off-site restaurant (since this may require driving around looking for restaurants and/or attempting to determine if a located restaurant is suitable).

Other problems arise relating to the process of paying for goods and services. For example, one problem that most employers face is that their employees will often need to purchase goods or services as a part of fulfilling their employment duties. For example, an employee who travels may need to pay for lodging, food and transportation. Currently, three main options exist for addressing this problem. First, the employer may require that the employee pay for all of the incurred expenses and then require the employee to seek reimbursement for the expenditures. This solution has substantial associated overhead as it requires the employee to provide detailed reports and associated information and requires that the employer audit that information to determine the validity of the claimed reimbursement. Employees often do not like this solution because, among other things, their employer may not reimburse them for a long period of time, i.e. the employee may not have the ability to cover the upfront costs and risks not getting reimbursed for some or all of the expenses which they paid. Lastly, this solution does not allow the employer to completely control expense costs because the employer can't directly limit the employee's actions.

Another solution is to issue the employee and advance of cash. While this solution no longer requires that the employee front payment for the expenses, the issues of auditing and validating expenses is even greater. In addition, this solution requires that the employer maintain a large reserve of cash for such events and requires that the employer seek re-payment from the employee of any unused funds. In many cases employers simply pay out the cash per diem knowing much of the money is pocketed by their employees, which thus increases the costs to the employer over the actual expenses incurred by the employees.

Lastly, the employer might issue the employee a credit card. While this solution again no longer requires that the employee front payment for the expenses, the employer still does not have direct control over the employees' actions. Unfortunately, it is far too common that employees use company-issued credit cards to purchase personal goods or to make other unauthorized purchases.

The present invention is directed at solving these and other problems.

### SUMMARY OF THE INVENTION

Aspects of the invention comprise methods and systems for issuing and/or redeeming value vouchers and bundling primary goods/services with secondary goods/services. In accordance with the invention, bundles of two or more goods or services may be generated, thus allowing businesses to offer consolidated offers of goods and services to customers and allowing customers to obtain two or more goods or services in a single transaction, from a single source. In accordance with the invention, a convenient means is also provided for paying for goods and services which provides complete control over the costs and the specific types of the goods and services.

One embodiment of the invention comprises methods and systems for issuing and redeeming value vouchers. In one embodiment, a voucher provider issues a value voucher, such as upon purchase thereof by a customer. The value voucher preferably has an associated voucher value and voucher identification information, such as a machine-readable code or a serial number. The customer may present the value voucher to a vendor as full or partial payment for goods or services provided by the vendor.

In the redemption process, the vendor preferably captures voucher identification information regarding the value voucher and transmits that information to the voucher provider for verification. Preferably, the vendor also provides a redemption amount, such as an amount of the customer's bill, to the voucher provider for comparison to the voucher amount.

If the voucher is invalid, the voucher provider transmits a rejection to the vendor. In that event, the vendor may seek another form of payment from the customer. If the voucher is valid, the voucher provider may transmit information to said vendor regarding a voucher credit against the bill, the voucher credit comprising the lesser of the voucher value or the redemption amount. In addition, the voucher provider then transmits payment to the vendor for the voucher.

In one configuration, the voucher comprises a value voucher which may be redeemed to pay for food or food services supplied by a food vendor. The value voucher might be purchased by a customer as part of a bundle, such as with lodging, or might be obtained by itself.

In embodiment, when the voucher is presented by a customer to a vendor, the vendor may initiate a mobile communication/computing device application. The vendor may use the mobile device to capture voucher information, such as by scanning a barcode, QR code or other machine readable code. The vendor might also capture receipt information using the mobile device, such as via a camera thereof. The vendor may transmit the captured information from the mobile device to a voucher redemption system. If the voucher is determined to be invalid, a notification may be immediately transmitted to the vendor so that the vendor can require the customer to provide other means of payment. If the voucher is valid, a redemption amount is determined so that the vendor can credit the customer's bill and the voucher system preferably transmits payment to the vendor. Preferably, this comprises transmitting a single use credit card number to the vendor's mobile communication device, thus permitting the vendor to use the single use credit card number in a point of sale system to effectuate a transfer of funds to the vendor.

In other embodiments, the vendor might provide voucher and other information via a computer or over the telephone. In yet another embodiment, the voucher might be issued with an associated single use credit card number and upon presentation the vendor may simply use the single use credit card number to effect payment. In this embodiment, the single use credit card number is linked to a financial account having certain restrictions, such as the identities of vendors which may redeem the voucher via the account.

In accordance with this aspect of the invention, a means for paying for goods or services is provided which is both convenient and provides cost control. For example, an employer may pre-purchase vouchers for their employees. Because of the controls associated with the vouchers, the employer can ensure that the vouchers are used for their intended purpose, such as for food (and not for personal items). In addition, the employer no longer has to require that the employee front payment for expenses, does not have to reimburse their employees for expenses, does not have to maintain large quantities of cash on hand for expenses, does not have to issue credit cards to the employees, and does not have the overhead associated with auditing and tracking employee expenses.

One embodiment of the invention comprises methods and systems for bundling primary goods or services which may be offered by a first entity, with secondary goods or services which may be offered by a second entity. In accordance with this aspect of the invention, a business can offer consolidated goods or services and a customer can, from a single source, obtain two or more goods or services that would, before the invention, have only been available from two different providers.

In a preferred embodiment of the invention, lodging services (such as in the form of a lodging reservation) may be bundled with food or food services (such as represented by food or meal vouchers), whereby a customer may make a single reservation that includes a room reservation from a lodging provider and a food/meal voucher associated with a food services provider(s).

In one embodiment of a system, a premium services provider system comprises a bundling server which obtains information regarding primary goods or services and secondary goods or services and creates bundles of the primary goods or services and the secondary goods or services. Information regarding primary goods or services may be obtained from an existing server or system which is associated with the primary goods or services provider. For example, lodging service information may be obtained from a lodging provider's existing customer reservation system. Information regarding secondary goods or services may similarly be obtained from a system associated with a secondary goods or services provider, such as a database of food vouchers.

Preferably, the bundling server creates bundles of at least one primary good or service with at least one secondary good or service based upon one or more defined rules. Information regarding bundles may be stored for later access or may be created upon request.

In one embodiment, a bundling website offers a customer the opportunity to make selections of various bundles. For example, a customer may make a reservation of a bundled lodging reservation and one or more food vouchers. Preferably, the bundle is offered at a single combined or unified price. The price may reflect a discount as compared to the sum of the individual prices of the goods or services if they were obtained separately.

Further objects, features, and advantages of the present invention over the prior art will become apparent from the detailed description of the drawings which follows, when considered with the attached figures.

### DESCRIPTION OF THE DRAWINGS

FIG. 1 schematically illustrates one embodiment of a system of the present invention;

FIGS. 2A-2E illustrate examples of graphical user interfaces relative to the practice of a method of the present invention;

FIG. 3 illustrates a flow diagram of a method of redeeming a value voucher in accordance with an embodiment of the invention

FIG. 4 schematically illustrates redemption of a value voucher by a customer of a restaurant; and

FIG. 5 illustrates a system for issuing and redeeming value vouchers.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Brief Overview

One embodiment of the invention is a method and system for bundling primary goods or services with secondary goods or services. Preferably, the primary goods or services and the secondary goods or services are offered, supplied or associated with different entities. For example, primary goods or services may be offered or supplied by a first entity, while secondary goods or services are preferably offered or supplied by a second entity. The primary entity, the secondary entity or an entirely different third entity preferably creates one or more bundles of primary goods and services and secondary goods and services. In other embodiments, the bundling system and method may be used to bundle goods or services associated with a single entity.

As described below, in one embodiment of the invention the primary service may comprise lodging offered by a lodging provider and the secondary good or service comprises food, such as represented by a food voucher. Thus, in a preferred embodiment, lodging services (such as in the form of a lodging reservation) are bundled with food or food services (such as in the form of food vouchers).

Preferably, the bundled goods and services are offered for purchase. In the case of lodging and food, a customer may make a single reservation which includes a lodging or room reservation bundled with a food/meal voucher. In this configuration, the system and method of the invention permit a lodging provider which does not have onsite food services to offer lodging services with a voucher which offers the guest food supplied by a secondary vendor.

Of course, as detailed below, lodging services might be combined with other secondary services. Further, the primary goods or services may comprise other than lodging services.

In a preferred configuration of the invention, bundling of lodging reservations and a secondary good or service is accomplished using an automated bundling system. The system obtains information regarding primary goods or services, such as information regarding available rooms from a lodging provider's reservations system, obtains information regarding one or more secondary services, and using various rules and a bundling engine, creates bundles of lodging and the secondary good or service in an automated fashion.

In accordance with this aspect of the invention, a business may offer new and existing combinations of goods and services that it could not previously conveniently and efficiently offer. Likewise, a customer can obtain a combination of two or more goods or services from a single source and in a single transaction, as opposed to having to obtain those goods and services from two or more different providers.

Another aspect of the invention comprises methods and system for issuing and/or redeeming value vouchers. In one embodiment of a method a value voucher is issued, such as by a voucher providers upon purchase of the voucher by a customer. A customer may present the value voucher to a vendor, such as in exchange for payment for goods or services provided by the vendor. The vendor captures voucher information and provides that information to the voucher provider to verify the voucher, including an amount which the customer is seeking to redeem from the voucher, such as the amount of the vendor's bill. If the voucher is validated or verified, the vendor is notified of the redemption amount, which amount is preferably the lesser of the voucher value or the redemption amount. The vendor is then paid, such as by transmitting a single use credit card number to the vendor which the vendor can then use via a point of sale system to transfer funds to their account.

In accordance with this aspect of the invention, a convenient means is provided for paying for goods and services. Most importantly, the vouchers provide cost control over expenses associated with goods and services. The vouchers also provide control over the type and nature of the goods or services which may be acquired.

Bundling System

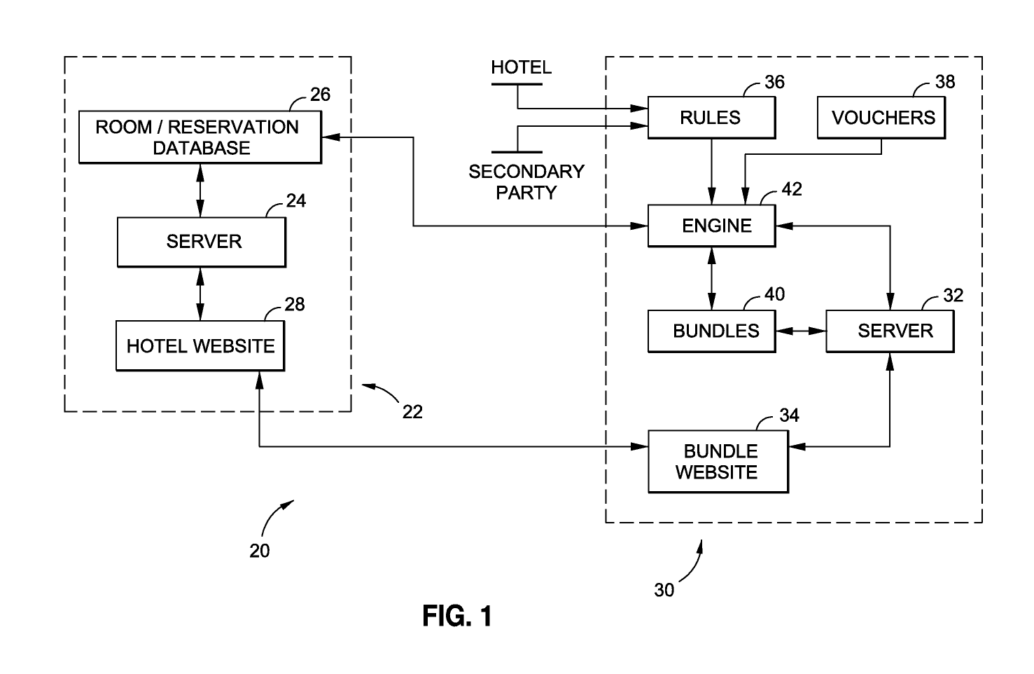

FIG. 1 illustrates one embodiment of a system 20 in accordance with the present invention. In one embodiment, the system 20 comprises a bundling system. The bundling system 20 bundles or combines two or more goods or services for purchase by a consumer in a single transaction.

As illustrated, the system 20 includes at least one customer reservation system (CRS) 22 which is associated with one or more lodging providers. As indicated below, such a lodging provider might be an entity, such as a “chain”, which operates multiple lodging properties, or might comprise individual lodging providers/locations. The lodging CRS 22 might be operated directly by the lodging provider or via one or more third parties.

In one embodiment, the lodging CRS 22 includes at least one CRS server 24. The lodging CRS server 24 is preferably configured to host a lodging reservation website 28. Such a website 28 may have various forms, including offering various content and features. Preferably, the website 28 presents information regarding one or more rooms offered by the lodging provider which are available for reservation and permits a user to input reservation information.

In one embodiment, lodging CRS server 24 comprises a computing device which comprises means for generating response data or information. Such means may comprise at least one processor. The processor is configured to generate reservation information, graphical user interfaces (web pages), etc., such as based upon the execution of machine readable code (i.e. software). Of course, the processor could also be pre-programmed or configured as hardware configured to generate variations of the data.

In one embodiment, the lodging CRS 22 includes means for storing information and/or instructions. Such means may comprise one or more memory devices. Such might comprise RAM, ROM (including EPROM, EEPROM, PROM) or other devices now known or later developed. The lodging CRS server 24 might include one or more other memory devices, such as for storing software or the like, as detailed below. For example, in one embodiment, the lodging CRS server 24 might include or be in communication with one or more mass data storage devices, such as one or more hard drives or the like.

In one embodiment, the lodging CRS 22 includes at least one database 26 of room information. For example, the room database 26 may include data regarding the rooms at the hotel, including which rooms are available and which ones are reserved on certain days/times, the room reservation rates for each room (which rates may vary by time), guest reservation information including guest name(s), addresses, payment information and the like. Of course, the room database 26 may store or include a wide variety of information in a wide variety of forms.

The lodging CRS server 24 preferably also includes at least one communication interface, by which the lodging CRS server 24 may receive and transmit information. The communication interface(s) may permit communications in accordance with various protocols and in various forms. In one embodiment, the communication interface may be configured so that the server 24 may transmit and receive data in accordance with a TCP/IP protocol over a wired network link with the Internet.

The lodging CRS server 24 might actually comprise a system or network of a plurality of elements or devices. For example, the lodging CRS server 24 might comprise a network or system which includes multiple servers and related devices such as data storage devices, user interface features and the like. Such might comprise, for example, a user station which includes a video display and one or input devices (such as a keyboard, mouse or the like). Such a user station may permit an operator to interface with and manage or control the lodging CRS server 24, such as to change operator settings and the like. The lodging CRS server 24 might also comprise a router and one or more separate computing devices. The functions of the various computing devices might be segregated.

In operation, the lodging CRS server 24 is preferably configured to support a hotel room reservation website 28. For example, upon a user accessing the lodging provider's website 28, the CRS server 24 may be configured to cause the user's computing device to display a graphical user interface or webpage. Such an interface may display various information regarding the hotel and rooms which are available for reservation. The lodging CRS server 24 is likewise preferably configured to receive information from a user, such as input regarding dates during which the user would like to reserve a room, the type of room, number of guests per room, etc. Based upon such information, the lodging CRS server 24 may check room availability and transmit information regarding available rooms and rates, etc. Likewise, the lodging CRS server 24 may receive input from a user regarding guest identity information and payment information.

In the case of a CRS system 22 which relates to multiple hotels or properties (such as in the case of a lodging provider which operates a number of individual hotels, for example), the CRS system 22 may connect to or gather information from one or more individual sources. For example, a hotel chain operator's CRS system 22 may poll individual hotels of the chain for current room availability and pricing and that information may be associated with an integrated database of the CRS system 22 which contains information regarding all of the hotels.

The CRS system 22 may be operated by a lodging provider or by a third party. For example, as indicated above, an individual hotel might operate such a system or a system might be operated by an entity having multiple properties. In other embodiments, the CRS system 22 might actually be operated by a third party.

Preferably, the system 20 includes a premium services provider system 30. In general, the premium services provider system 30 is configured to obtain information regarding one or more primary goods or services and one or more secondary goods or services and, in an automated fashion, bundle them. In a preferred embodiment, as detailed below, the premium services provider system 30 is configured to obtain information from a lodging CRS 22 and use separate information regarding one or more secondary goods or services and, based upon various criteria, create one or more bundles of lodging/room reservations and a secondary good or service.

As one example, the premium services provider system 30 may include at least one bundling server 32. The bundling server 32 is preferably configured to host one or more bundle websites 34. Such a website 34 may have various forms, including offering various content and features as described below. Preferably, the bundle website 34 presents information regarding combinations or “bundles” of primary and secondary goods/services, and most preferably, lodging and one or more secondary goods and/or services. In a preferred embodiment, the one or more secondary goods and/or services comprise food, such as in the form of one or more food/meal vouchers. The bundle website 34 is also preferably configured to receive information from a user for the purpose of making a reservation/purchasing a bundle.

The premium services provider system 30 preferably also includes one or more data storage devices. Such devices may be part of the bundling server 32 or be separate there from. As described below, the one or more data storage devices may be configured to store rules 36, such as in a rules database, voucher information 38, such as in the form of a voucher information database, bundle information 40, such as in the form of a bundle database, and computer readable/executable code (“software”) for execution by the bundling server 32.

In one embodiment, the premium services provider system 30 also includes a bundling engine 42. The bundling engine 42 may comprise, for example, software which is executed by the bundling server 32 or another computing device. As described below, the bundling engine 42 is preferably configured to use the rules 36 to create bundles 40 based upon voucher information 38 and lodging/room data.

The rules 36 preferably comprise information which is used by the bundling engine 42 in determining the criteria for bundling primary goods and services with secondary goods and services. In one embodiment, a rules database stores one or more rules 36 which comprise information regarding how the bundling engine 42 should create one or more bundles. A bundle comprises a combination of at least a primary good or service with at least one secondary good or service. In a preferred embodiment, a bundle comprises a combination of a lodging service (such as represented by a lodging reservation) along with food or a food service (such as represented by a food voucher). Information regarding such bundles 40 may be stored in a bundles database.

As indicated, the rules 36 which are stored in the rules database may comprise information which is provided by a hotel and/or a secondary party (the premium services provider or a third party).

Information regarding one or more vouchers 38 may be stored in a voucher database. For example, in the case where the secondary good/service comprises food, the vouchers database 38 may store information regarding food/meal vouchers. Such a food vouchers may represent food which a user is entitled to obtain, as described in more detail below.

Additional aspects of the invention will be appreciated from a description of the operation of the system and one or more examples.

Still referring to FIG. 1, in accordance with a method of the invention, a premium services provider may bundle one or more secondary goods or services with one or more primary goods or services. In the preferred embodiment, the primary service comprises lodging and the secondary good comprises food. In a preferred embodiment of the invention, a customer may reserve or purchase the bundled goods/services.

As illustrated, the bundle engine 42 preferably obtains information regarding available lodging, such as one or more hotel/motel rooms, from a lodging provider's CRS 22, including the room/reservation database 26. In this regard, at one or more times a communication link may be provided between a lodging provider's CRS 22 and the premium service provider system 30.

The bundling engine 42 also obtains information regarding one or more food vouchers 38. The bundling engine 42 then generates one or more bundles based upon the rules 36 (such as stored in a database).

As one example, Hotel A may allow a premium services provider to bundle a queen bed room with a $20.00 meal voucher. Hotel A may input or provide rules 36 by which Hotel A allows such bundling. The bundling engine 42 accesses Hotel A's room/reservation database 26 to obtain information regarding the queen bed rooms and the associated rates. The bundling engine 42 also accesses information regarding $20.00 meal vouchers 38, such as from a voucher database. The bundling engine 42 then creates one or more room and food bundles. For example, a queen bed room from Hotel A on September 1 may be priced at $65.00. Hotel A may desire to bundle on a $20.00 meal voucher at a $10.00 overall discount (as determined by the rules 36), such that the bundle comprises a queen room and $20.00 meal voucher for a price of $75.00 on September 1.

Of course, it will be appreciated that different rooms may have different prices and the same room may have different prices depending upon the day of the week or the like. The bundling engine 42 preferably accesses and utilizes the room information directly from the lodging provider's CRS 22 in generating the bundles, thus reflecting the lodging provider's own room information.

Likewise, various rules may be applied when generating a bundle. For example, a hotel may set rules regarding the total bundle price, the amount of discount to be applied to the total price in generating the bundled price, what rooms a bundle may be applied to, what days or times a bundle may apply to and a wide variety of other rules.

While the system 20 illustrated in FIG. 1 only shows a link between a single lodging provider's CRS 22 and a premium service provider system 30, the premium service provider system might be linked to multiple lodging CRSs 22, such as those of Hotel A, Hotel B, etc. In this manner, different bundles may be generated which correspond to the different lodging providers.

It will also be appreciated that the system 20 which is illustrated in FIG. 1 is just one embodiment of a system which could be used to implement the invention. For example, a premium service provider system 30 might have other configurations and still be capable of obtaining information regarding primary and secondary goods and services and then creating bundles in an automated fashion. Thus, while FIG. 1 illustrates a bundling system 20 which is particularly configured to bundle lodging reservations with food vouchers, the system 20 might have other configurations depending upon the goods and services which are being bundled. For example, as detailed below, in the case of bundling of car rental reservations, a premium service system might be configured to link to a car rental company's reservation system. Various existing systems permit lodging and related reservations, including systems for travel agents and the like. While these systems have various configurations, such systems might be modified in various manners to implement the functionality described herein, either by directly modifying the system or by integrating such an existing system with a bundling system as described herein.

In addition, as described herein, while one entity may run or operate the lodging provider CRS 22 and another entity may run or operate the premium service provider system 30, the portions of the bundling system 20 could be combined so as to be operated by a single entity. In another embodiment, second entity might operate a voucher or other system and a third entity (different than the first entity which provides the lodging or other primary good or service or the second entity which provides the food or other secondary good or service) might operate the premium services system 30.

Example Implementation

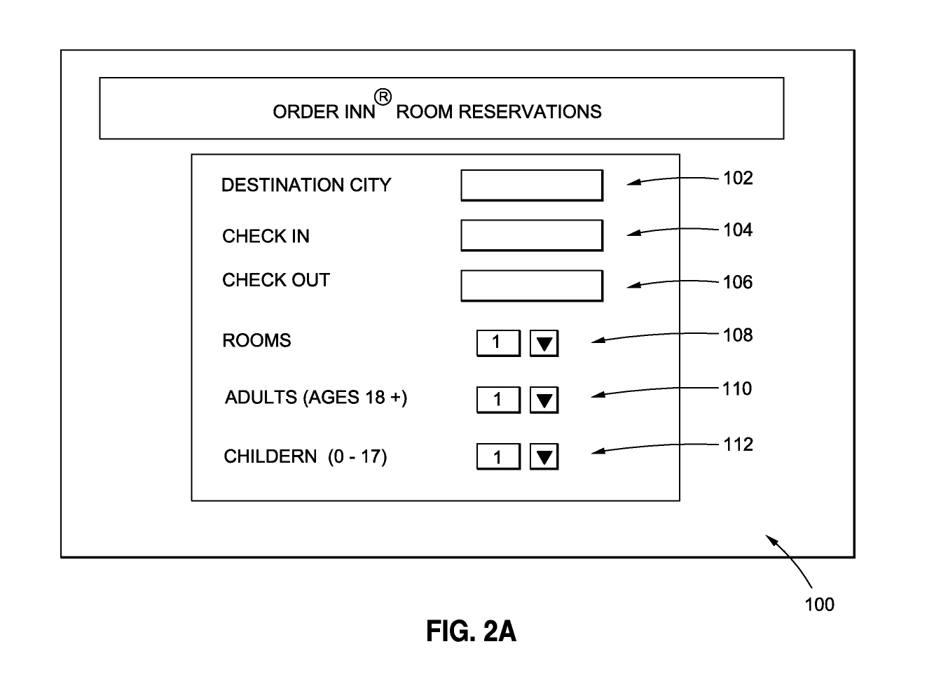

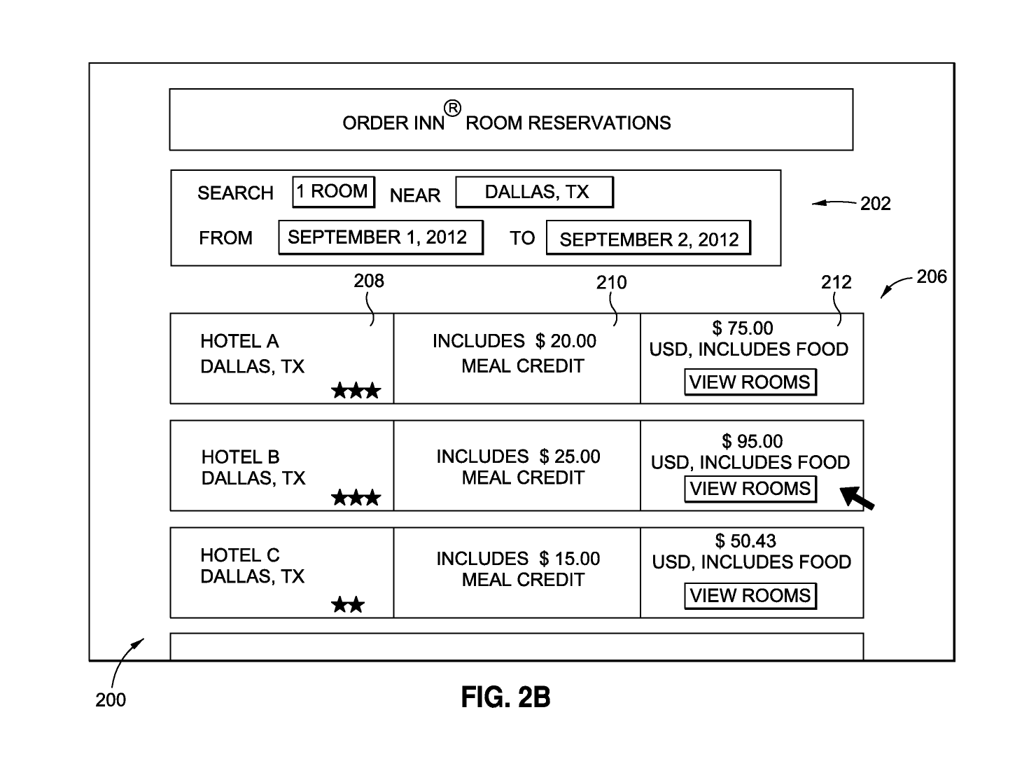

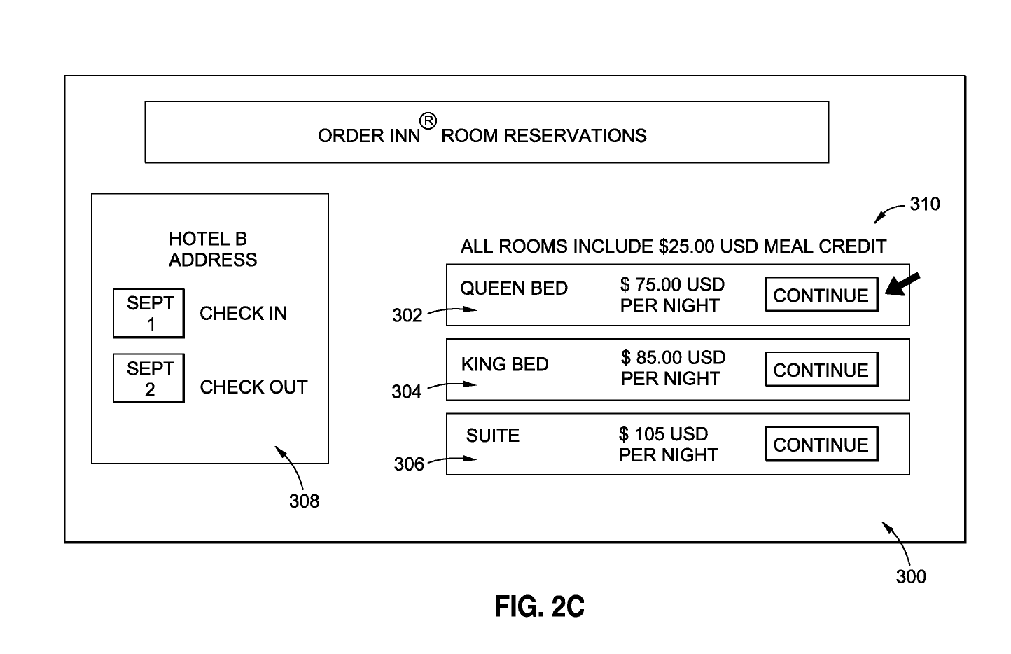

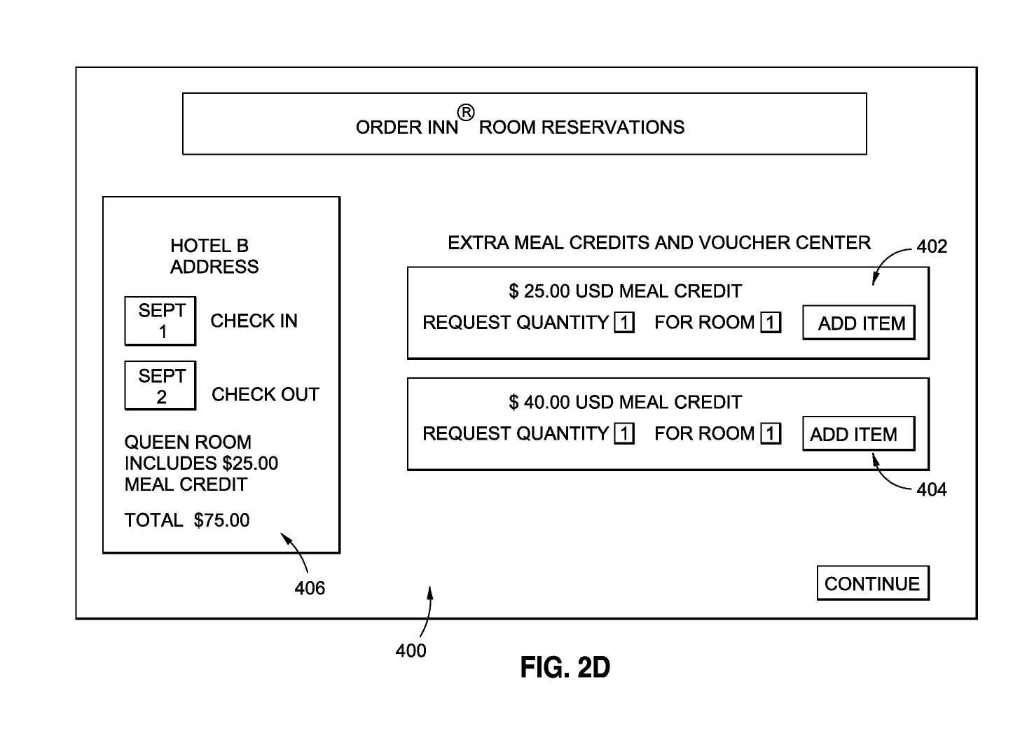

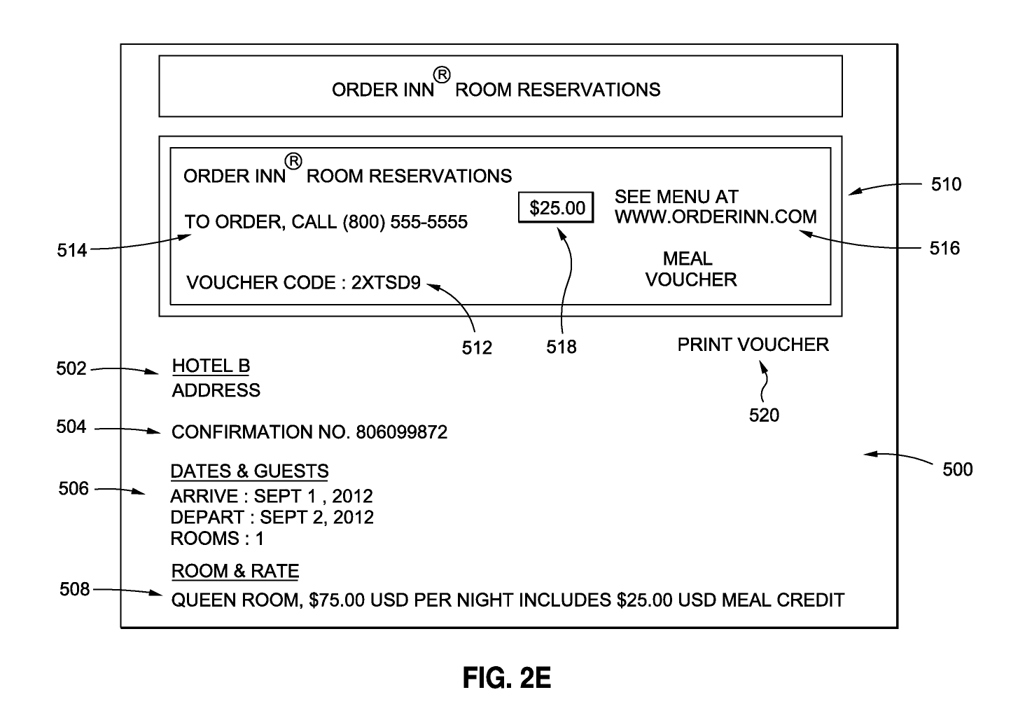

One particular example of the invention will be described with reference to FIGS. 2A-2E. As illustrated in FIG. 2A, the premium services provider Order Inn may operate a premium services system 30, including associated an associated Order Inn Room Reservations website 34.

As illustrated, the website 34 may be supported by one or more bundling servers 32 which cause a first graphical user interface 100 or “home page” to be displayed on a display associated with a user's computing device. The first graphical user interface 100 may display various information regarding the goods and services offered at the website. In one embodiment, the information may include one or more fields via which a user may input information. For example, as illustrated, first graphical user interface 100 may include a destination field 102, such as to permit a user to input or select a desired destination at which lodging is desired. Such a field 102 may permit input or selection of a city, state, country, county or other information which designates a destination.

The first graphical user interface 100 may also include a check-in field 104, such as to permit a user to input or select (such as via a displayed calendar) a desired check-in date or starting date for the reserved services. For example, the check-in field 104 may permit a user to input or select a particular day, month and year (or other time). Likewise, the first graphical user interface 100 may also include a check-out field 106, such as to permit a user to input or select (such as via a displayed calendar) a desired check-out date or ending date for the reserved services.

Relative to a lodging reservation, the first graphical user interface 100 may also include an “adults” field 110 for indicating or selecting a number of adults for whom the services are intended to be provided. Likewise the first graphical user interface 100 may include a “children” field 112 for indicating or selecting a number of adults for whom the services are intended to be provided.

As one example, the user might input the destination “Dallas” for a trip to Dallas, Tex., USA. The user might input a check-in date of Sep. 1, 2012 and a check-out date of Sep. 2, 2012 and select a single (1) adult and zero (0) children.

The user's input(s) are directed to the bundling server 32 which preferably conducts a search of the bundles in the bundles database 40 to determine if any bundles are responsive to the user's request. In this example, the bundling server 32 preferably checks the bundles database 40 for bundles of rooms and meal vouchers which meet the requirement of lodging in Dallas, Tex. with available rooms on the designated check-in and check-out dates, for a single adult.

As illustrated in FIG. 2B, the bundling server 32 may locate multiple responsive results. In this example, the bundling server 32 has located Hotels A, B and C which all have room bundles which meet the user's requirements. As illustrated in FIG. 2B, the bundling server 32 may cause the user's computing device to display a second graphical user interface 200 or “initial results page.” The second graphical user interface 200 may be configured to display responsive results to the user's inquiry.

For example, the second graphical user interface 200 may display information which confirms the user's inputted request/query 202. The second graphical user interface 200 may also display relevant results (if such exist, if no responsive results were obtained, the user might be so informed). As illustrated, results were obtained for Hotel A, Hotel B and Hotel C. In one embodiment, the results identify the location at which lodging is available, the secondary good/service which is bundled with the lodging, and the total price of the bundle/package.

For example, a first result 206 includes information which identifies Hotel A 208 as the lodging provider (which information may include the name of the lodging provider, the location—such as Dallas, Tex., the address, and/or other information), the bundled secondary good or service 210 such as a $20.00 meal credit, and the total price of the bundle/package 212, such as $75.00. Similar information may be similarly provided relative to other results.

In one embodiment a user is given available options for bundles, including a choice of lodging by location and/or provider, total package price, and one or secondary goods/services. The user may then make a selection of one of the results. As illustrated, the user has used a cursor to select the package offered by Hotel B.

In one embodiment, in response to the user's selection of particular lodging, the user may be given additional options. For example, as illustrated in FIG. 2C, the bundling server 34 may cause the user's computing device to display a graphical user interface 300 which shows lodging options from the selected provider. Of course, these options may vary depending upon the particular lodging provider. In this example, the bundling server 34 has determined that three bundles from the selected lodging provider meet the user's criteria: (1) a queen bed room at a bundled price of $75.00/night 302; (2) a king bed room at a bundled price of $85.00/night 304; and (3) a suite at a bundled price of $105.00/night 306. As illustrated, along with each of these selections, information may be displayed 310 regarding the one or more associated or bundled secondary goods or services.

As illustrated, the graphical user interface 300 may display additional information, such as information which reflects the user's selected lodging provider and desired check-in and check-out dates 308. In this example, the user has selected the queen bed option 302, such as by clicking a “continue” button with a cursor.

As illustrated in FIG. 2D, the user may be given other or additional options. As illustrated, the bundling server 34 may cause the user's computing device to display a graphical user interface 400 of secondary goods/services options.

For example, the user may be given the option of adding one or more secondary goods or services to the selected bundle. For example, relative to a bundle which includes a room and food (such as a meal voucher), the user may be given the option to purchase additional food. As illustrated, the user has been given the option of purchasing one or more matching food/meal vouchers 402 (i.e. where the bundle included a $25.00 meal voucher, the user has been given the option of purchasing another $25.00 meal voucher). As illustrated, the user has also been given the option of purchasing one or more different or upgraded meal vouchers, such as a $40.00 meal voucher 404.

Once again, the graphical user interface 400 may display additional information, such as information which reflects the user's previously input information and/or selections, such as the user's selected lodging provider, check-in and check-out dates and selected room option 406.

After the user has made any selections of additional options, if any, the user may continue the purchase/reservation process. Though not illustrated, similar to standard website purchase processes for other goods and services, after a user's final selection of items, the bundling server 34 may cause one or more graphical user interfaces to be displayed by the user's computing device which prompt the user for check-out or purchase information. These one or more graphical user interfaces may provide fields for the user to input their name, billing address, residence/mailing address, telephone, fax number, email address and the like, as well as to provide payment information such as credit card information.

Once the user has provided any requested user identity and/or payment information, the bundling server 34 may cause the user's computing device to display a receipt page/interface 500. This interface 500 may, for example, provide information to the user regarding the name and address of the lodging provider 502 at which the lodging has been reserved, the lodging confirmation number 504, the check-in and check-out dates and number of guests 506 and the lodging rate and associated bundled good/service 508.

In addition, the interface 500 may display information regarding the bundled secondary good or service, such as the above-described meal voucher 510. In one embodiment, an image of the meal voucher 510 is displayed. This image may include information regarding the meal voucher 510, such as a unique voucher code 512, contact information for redeeming the voucher such as a telephone number 514 and/or website address 516 or locations where the voucher may be redeemed, and information regarding the value of the voucher 518. In one embodiment, a user could write down the voucher code 512 and use that code in order to redeem or use the voucher, or the user might use a print function/icon 520 to cause the voucher 510 to be printed on physical media, such as via a printer associated with the user's computing device.

Relative to the specific example just described, the user has reserved lodging with a particular lodging provider on specified dates and may thus travel to the identified lodging location to use their reserved room. In addition, the user has received a bundled meal voucher. As described below, such a meal voucher may be used in many ways, but in one method the user may use the voucher during the user's stay, such as by ordering food for delivery to the user's room or by travelling to a food service provider, wherein the meal voucher serves as full or partial payment for the ordered food.

Additional aspects of the invention will now be described.

In a preferred embodiment of the invention, lodging services are bundled with food or a food service. In one embodiment, the lodging and food are bundled as part of a reservation process whereby a customer may, via one reservation process, reserve both food and lodging.

As indicated above, more than one primary good or service may be bundled with one more secondary good or service. For example, a lodging reservation might be bundled with two or more food vouchers, such as separate vouchers for breakfast and lunch, lunch and dinner or the like. As another example, a lodging reservation might be bundled with a food voucher and a transportation voucher, such as a cab voucher. In this manner, a single bundle may be obtained which includes lodging, transportation and food. As another example, the primary good or service might comprise a train ticket and that ticket might be bundled with a food voucher or a cab voucher (such as to permit an employee to travel by train from their office to a remote city for a meeting, including from the train stain in that remote city to the location of the meeting). In another embodiment, a restaurant voucher might be bundled with a cab or other transportation voucher. For example, a restaurant might offer travelers a food voucher and associated cab voucher which enables the customer to pay for transport from their hotel to the restaurant and back.

Of course, the bundled lodging may have various forms. For example, the lodging may be provided by a hotel, motel, bed and breakfast, time share, vacation rental or other type of lodging provider.

It will also be appreciated that when the secondary good or service comprises food, elements other than vouchers might be used to designate the food or food service. For example, a credit card, debit card, gift card, currency, coupon or other element might be bundled with the primary good or service, such elements simply representing the food or food service.

Regardless of the particular goods and services, an aspect of the invention is the joinder of the goods and services which are initially offered by two different entities so that those goods and services can be obtained by a customer in a single transaction via a single entity. This allows a business to offer more desirable combinations of goods and services at lower cost and expense than if the business directly provided the goods and services. In addition, the time and cost to a consumer in obtaining the goods or services is reduced by the consumer obtaining them in a single transaction via a single entity, rather than having to source and obtain the goods or services from two or more different entities. At the same time, as indicated herein, when one or more of the goods or services are obtained using one or more vouchers, the cost of the goods or services can be controlled, as may be the specific goods or services which are obtained using the voucher(s).

A voucher might be redeemable in many ways, such as relative to a specifically identified food vendor (such as a hotel restaurant, outside restaurant or other food provider). In one preferred embodiment, the meal or food voucher may be redeemable via third party (i.e. different than the lodging provider and/or via a food service provider which is not at the site of the lodging), such as in the manner described in U.S. patent application Ser. No. 11/082,450, filed Mar. 17, 2005, which is incorporated herein in its entirety by reference. As disclosed therein, a broker may contract with one or more food service providers, such as restaurants, to affect a supply of food to guests of one or more lodging locations. As disclosed therein, the user may use an in-room menu to contact the broker, via which the user may place an order for food which is supplied by the third party food vendor associated with the broker, which order is monitored and quality-controlled via a food services broker. In one embodiment, the meal voucher may be supplied by the broker. This voucher may then be accepted by each food vendor associated with the broker. For example, when placing a food order via the food broker, the customer may provide the meal voucher code. The broker or food services provider may enter the voucher code into a computing device which checks the code with the server 34, thus verifying that it is available for redemption. If so, the value of the voucher may be credited against the cost of the user's food order as supplied by the third party food vendor. The voucher which is associated with the designated code is then preferably updated by the bundling server 34 to a “redeemed” or partially redeemed (such as showing a remaining value) status to prevent its subsequent redemption.

A bundled meal voucher may have various features or forms. For example, a bundled meal voucher may have a particular monetary-equivalent value, may be usable before a particular expiration date or on a certain day/date (or during a particular period of time), may be usable only at specified locations, or have other terms and conditions for use. As indicated above, a meal voucher may be generated electronically and be printable or may simply be represented by a voucher code. In other embodiments, a meal voucher may be emailed or mailed to a user. For example, a meal vouchers having an associated physical media such as in the form of a paper voucher/ticket, in the form of a card or the like, may be provided to the user.

As indicated above, a customer might be permitted to change attributes of the meal voucher, such as by paying to increase the value of the voucher. A customer might also be permitted to pay to change the expiration of the voucher. For example, when a single voucher is tied to a single lodging night reservation, the voucher might be usable only on the night of the lodging reservation. However, a customer might be permitted to pay to cause the voucher to be redeemable within 1 month of the lodging reservation date.

Preferably, the system 20 of the invention is configured to track the bundled goods/services, such as for redemption and auditing purposes. First, relative to a lodging/food bundle, the user's identity information and/or payment information may be saved by the bundling server 34, such as in one or more data files. In addition, the bundling server 34 preferably forwards such information to the lodging provider's CRS server 24 for storage in the lodging provider's CRS 22. In this manner, when the user travels to the lodging location to check-in, lodging provider personnel may verify the user's reservation directly with the provider's CRS 22.

In one embodiment, when a meal voucher is created, information regarding that voucher is stored in the system 30. In this manner, as described above, the voucher may later be identified, such as to determine whether or not it is available for redemption. As indicated above, the status of a voucher may be stored, such as to indicate whether the voucher: (1) is available for redemption; (2) is expired; or (3) was redeemed or partially redeemed (in the case, for example, where a voucher may be partially redeemed and thus have some remaining usable value).

Of course, the premium services system 30 may be auditable. For example, a user station which is in communication with the bundling server 34 may be used to audit reservation or other records. For example, such a user station might be used to determine the status of all vouchers for a particular period of time (i.e. which ones have been redeemed, which have expired and which are still active).

As indicated above, various rules 36 may be provided to the bundling engine 42. These rules may be determined by the providers of the bundled goods or services or otherwise. The rules may vary depending upon the provider and/or the goods/services. As one example, a particular hotel may input a rule that all bundled room and meal voucher prices are discounted by $10 from the standard price on weekdays and $20 on weekends (e.g. if the hotel's standard room rate is $70 and the bundled meal voucher is for $20, then the bundled price is discounted by $10 to $80 during weekdays and to $70 on weekends); the bundled prices may not be discounted on weekends, no bundling may be offered for certain rooms or on certain days, the bundling may be for specific combinations of rooms and vouchers, etc. It will be appreciated that the rules 36 may have various sources. For example, rules 36 may be provided or set by the provider of the primary good/service, the secondary good service, or a third entity such as a separate operator of the premium services system 30.

In one embodiment of the invention, a user may seek the bundled services by accessing the bundle website 34. In one configuration of the invention, such a website 34 may be “generic”, meaning that it may offer bundled goods and services from more than one party, such as Hotels A, B and C. In another embodiment of the invention, the website 34 may support a “white label” site, wherein a user may access particular web pages which offer bundles which are unique to one particular provider or which is unique to the customer. For example, a user might access a main or generic home page at www.orderinn.com. However, a user who only wants to reserve a bundle which includes lodging from Super 8 hotels might access a specific Super 8 page at www.orderinn.com/Super8. By accessing such a page, the user might only be offered bundles which include lodging offered by Super 8 hotels.

In another configuration, as illustrated in FIG. 1, in one embodiment the bundling website might be accessible from a provider's website. For example, the Super 8 hotel website 28 might include a link to the Super 8 bundle page at the bundle website 34. In that event, a customer seeking a Super 8 reservation at the Super 8 website might be presented with a link at that webpage which offers the customer the opportunity to “reserve lodging and food.” If the customer clicks on that link they may be directed to a Super 8 bundle webpage which is hosted by the bundled website 34. Preferably, that specific bundle page is “Super 8” specific and thus presents the customer only with bundles which include Super 8 lodging.

Lastly, the system 30 might be configured to offer or present customer-specific bundles. For example, a particular customer might desire only bundles of lodging from Hotel A and B with associated food vouchers. The customer might access the bundle website 34 and present a customer code. This code may cause the bundle website 34 to present a customer-specific menu or page and present only results which meet the customer's pre-designated criteria. In this regard, the bundling system 30 may be configured to present information in various fashions.

As indicated herein, the premium services provider system 30 may be operated by one or more parties, including a provider of secondary goods/services or a third party or third entity who bundles goods and services from primary and secondary entities (i.e. where the third party does not offer either the primary or secondary goods/services). For example, a lodging provider which already operates a CRS 22 might associate that system 22 with a premium services system 30 to thus create bundles of their lodging with one or more secondary goods or services in an automated fashion.

It will also be appreciated that the system 20 could be used to bundle other goods and services than those which are specifically detailed above. For example, a primary lodging service could be bundled with other secondary goods or service (other than food/food vouchers). In such event, information regarding vouchers 38 may be replaced by other information, such as show ticket information or the like. Likewise, other primary goods or services (than lodging or lodging reservations) might be bundled with food (such as food vouchers).

While the terms “primary” and “secondary” have been used herein to designate different goods and services, the use of such terms does not imply that one good or service is more important than the other, though in one configuration a primary good or service may be a main good or service and a secondary good or service may be one which relates to or is particularly applicable to, the primary good or service. However, the goods and services might simply be referred to as first and second goods and services or by other terminology.

Voucher Redemption

Another aspect of the invention comprises methods and systems for issuing and redeeming vouchers. It will be appreciated that this aspect of the invention has particular utility to the system described above (and thus the redemption of vouchers issued as part of a bundle), but may be used entirely separate there from and in other environments. In a preferred embodiment, the vouchers comprise value vouchers which are usable by a customer or patron to pay for all or a portion of the cost of goods and/or services (such as food). The vouchers, however, do not comprise currency and preferably have one or more limitations upon their use.

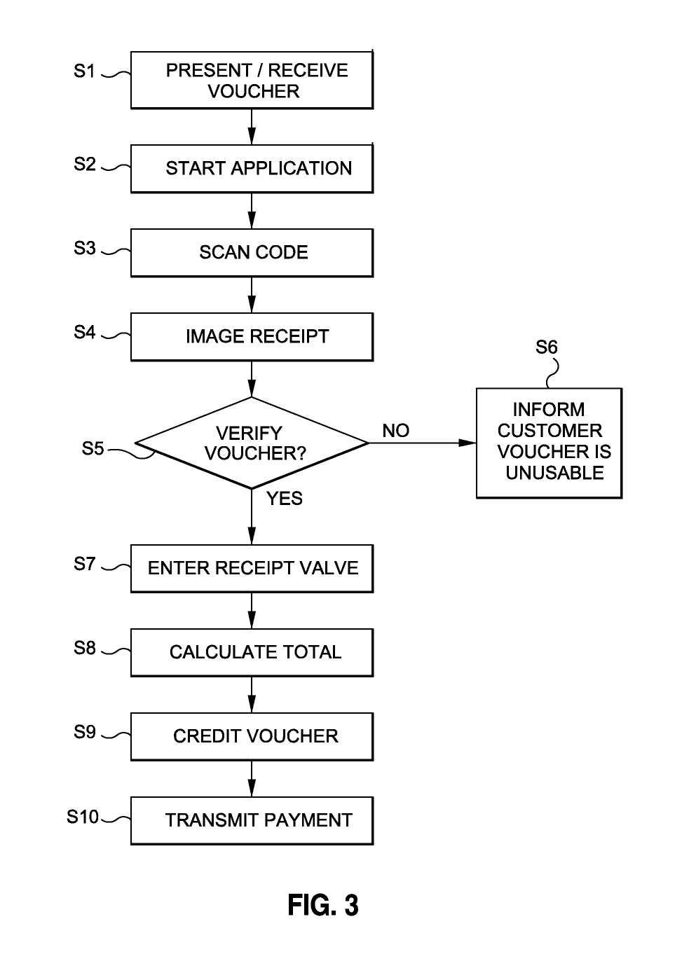

One embodiment of a method of redeeming a voucher will be described with reference to FIG. 3. This embodiment of the invention has particular utility to a food or meal voucher which is presented by a user to a food vendor, such as a restaurant. The voucher may have been issued as part of a lodging bundle as described above. As such, an example of the invention will be described relative to such an implementation. It will be appreciated, however, that the invention has many other implementations.

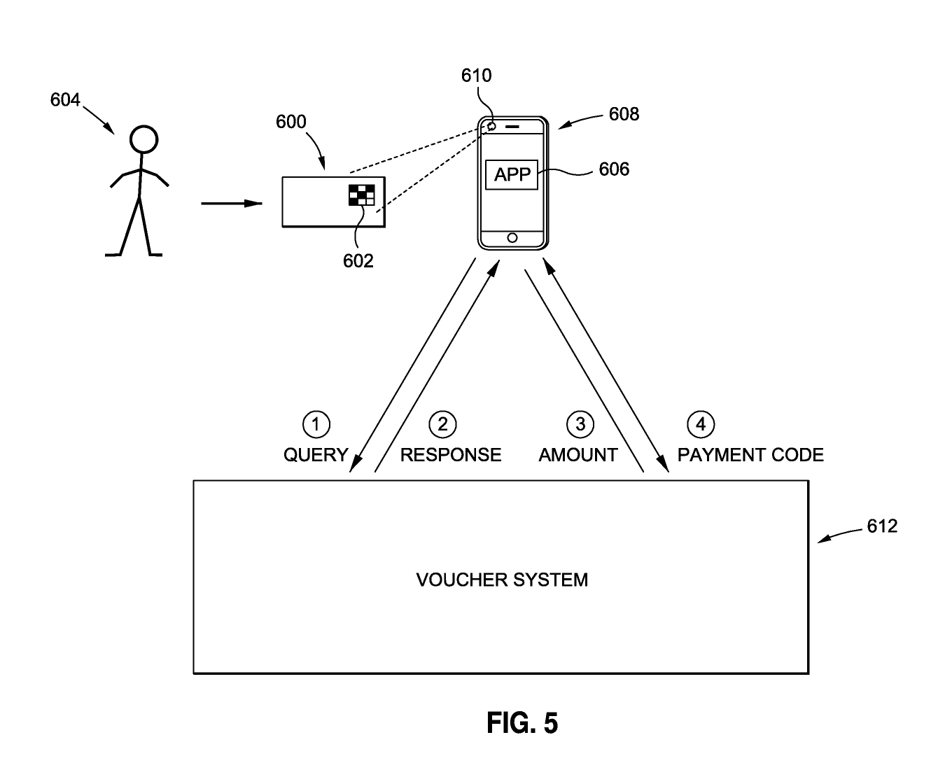

In a step S1, a user presents a voucher. As illustrated in FIG. 5, the user may comprise a customer 604 of a food vendor, such as a restaurant. The voucher 600 may comprise a food voucher which the customer obtained as part of a lodging and food bundle, such as described above. However, the voucher 600 might have been obtained in other manners, such as by purchasing the voucher apart from a bundle.

As indicated above, the voucher 600 may have various forms. As illustrated in FIG. 5, the voucher 600 may include voucher and/or redemption information. In one embodiment, this information may include a voucher code 602. The code 602 might comprise, for example, a barcode, QR code or other machine-readable information. As detailed below, this information may be used to identify the voucher, information regarding the voucher (such as its value or status), and/or include specific voucher information such as the value of the voucher.

Of course, the information might comprise other than a machine-readable code 602, such as human readable text which provides information regarding the voucher (such as a voucher serial number), where it may be redeemed, steps for redeeming the voucher, the value of the voucher, etc. In addition, forms of machine-readable information may be provided other than printed codes, such as information which is associated with a magnetic stripe or a RFID tag. Printable voucher formats have the advantage that the voucher 600 can be generated and transmitted electronically (such as over the Internet or by email) to the customer and then be printed by the customer.

It will be appreciated that while the voucher 600 may be printed on media such as paper, the voucher 600 could be represented by electronic information. For example, voucher information might be transmitted to a customer electronically and the customer might cause an image of the voucher to be displayed on a mobile communication device or computing device, such as their mobile phone.

The customer 604 may, for example, present the voucher 600 as full or partial payment for food obtained from the food vendor. For example, the customer 604 may present the voucher 600 to a food service in order to settle a bill.

In a step S2, the food vendor preferably initiates a voucher redemption application. As illustrated in FIG. 5, the application 606 may comprise machine executable instructions or “software” which is executed by a processor of a computing device. In a preferred embodiment, the application 606 is in the form of an “app” which is associated with a mobile computing device 608, such as an Apple IPhone® or similar device (a tablet, PDA, etc.). Such an application might, for example, be downloaded by the food vendor to a device which belongs to the food vendor and which is used by the employees thereof, or which is downloaded to the devices of the employees themselves.

In a step S3, the food vendor preferably obtains information regarding the voucher 600. In a preferred embodiment, this step preferably comprises scanning the voucher code 602 of the voucher 600. For example, relative to the embodiment illustrated in FIG. 5, once the voucher redemption application 606 has started, it might present a visual request (such as via an electronic video display of the device) to the user of the device 608, such as “please scan the voucher code.” The food vendor employee may use an information reader (such as a code scanner) 610 of the mobile communication device 608 to scan the code 602. Of course, the information might be obtained manually, such as by reading an alpha, numerical and/or alpha-numerical code from the voucher 600 and, for example, inputting that information to the device 608 via a keypad, touch screen or other input device of the mobile communication device 608.

In a step S4, the food vendor preferably inputs or provides information regarding the food service bill. For example, relative to the embodiment illustrated in FIG. 5, the voucher redemption application 606 might present a visual request (such as via an electronic display of the mobile device 608), such as “please take a picture of the customer's receipt.” The food vendor employee might scan or otherwise input an image of the food service bill/receipt. For example, the employee might scan the food bill with a camera of the mobile communication device 608.

In a step S5, the food vendor may transmit information regarding the voucher 600 for verification. As illustrated in FIG. 5, the information may be transmitted from the mobile communication device 608 to a voucher system 612 as at Query 1. Additional details of such a system 612 are described below. However, such a system 612 may comprise one or more computing devices, such as servers. The system 612 may be configured to store information regarding one or more vouchers 600, such as the identity of the voucher, the value of each voucher, information regarding the status of the voucher, etc.

In one embodiment, the food vendor transmits voucher information from the mobile communication device 608 to the voucher system 612, such as via a wireless communication link. For example, once an image of the receipt has been obtained, the voucher redemption application 606 might display a button labeled “send voucher information for verification.” In response to the employee's input, the application 606 may package information regarding the voucher and transmit that application to the voucher system 612. In one embodiment, such might comprise transmitting information from the mobile communication device 608 to the voucher system 612 via the Internet, such as using TCIP/IP or other protocols.

Preferably, the voucher information which is transmitted from the food vendor is used to verify or validate the voucher. For example, the voucher code 602 which was scanned by the food vendor may be transmitted to the voucher system 612. The voucher system 612 may use the code to look up or otherwise identify the voucher and determine its status. For example, to validate the voucher, the voucher system 612 may determine if the voucher has already been redeemed, is being redeemed at an approved or designated vendor or location, is being redeemed in a time frame during which the voucher is valid, or to determine if other conditions associated with the voucher are met (of course, such validation may require other information, such as the vendor supplying a vendor code to the vendor system to verify that the voucher is being redeemed at a designated approved redemption location for that voucher).

If the voucher code 602 is not valid or if the voucher which corresponds to the code has already been redeemed, in a step S6 the voucher system 612 may transmit a response to the food vendor that the voucher is unusable (as at Response 2 in FIG. 5). For example, this message may be transmitted back to the mobile communication device 608 which then (such as via the voucher redemption application 606) causes such a message to be displayed to the food vendor employee. The employee may then notify the customer so that the customer can provide other means of payment for the food services.

If the voucher system 612 determines that the voucher 600 is usable, then the system 612 may change the status of the voucher 600 to a “redeemed” or “partially redeemed” status. In one embodiment, the status of the voucher 600 may depend upon the amount of the food service bill relative to the value of the voucher.

In this regard, in a step S7, assuming that the voucher 600 is valid and can be used, the food service employee may be so notified (again at Response 2 in FIG. 5) and be prompted to enter the value of the food service bill. For example, the employee might use a keypad or touch screen of the mobile communication device 608 to enter a numerical value of the bill.

In a step S8, the voucher redemption application 606 might be configured to make adjustments to the amount to generate a final submitted value or total bill. For example, relative to a food service bill, the application 606 might automatically add a gratuity onto the bill amount. The gratuity might comprise, for example, a percentage of the food service bill, such as 10%, 15%, 20% or other values. In one embodiment, the total of the bill or other amount to be redeemed might be displayed to the employee and be compared to the value of the voucher. This final value is submitted to the voucher system 612 for credit, such as at Amount 3 illustrated in FIG. 5.

In a step S9, a redemption value is credited. Preferably, this amount comprises the lesser of the final submitted value or the value of the voucher 600. For example, assuming that the final submitted value is $52.00 and the value of the voucher 600 is $40.00, $40.00 would be credited to the customer's bill. If the redemption amount were $35.00 and the voucher 600 had a value of $40.00, then $35.00 would be credited.

Of course, the final submitted value is preferably utilized to update the status of the voucher 600. For example, relative to the above-described scenarios, in the first scenario the entire value of the voucher 600 is utilized. Thus, the voucher system 612 would show that the final submitted value was $52.00 and that the entire $40.00 value of the voucher 600 was applied, thus causing the voucher to be entirely redeemed. On the other hand, in the second scenario the voucher system 612 would show that the final submitted value was $35.00 and that only $35.00 of the voucher was applied, thus causing the voucher 600 to only be partially redeemed, as the voucher 600 has a remaining $5.00 value.

In a step S10, the food vendor is preferably paid (as shown a Payment Code 4 in FIG. 5). In one preferred configuration, the voucher system 612 transmits a single use credit card number which is associated with an account to which the amount has been credited. In the case where a single use credit card number is provided to the food vendor, the voucher system 612 may thus communicate at one or more times with a banking system in order to obtain such numbers corresponding to the associated monetary accounts and also to effectuate the transmission of funds from, for example, the voucher system operator to those accounts.

As detailed below, the particular redemption and payment amounts may vary depending upon various criteria. For example, the redemption amount or payment amount may vary depending upon criteria relating to gratuities, included or excluded food items (for example, redemption might only be permitted for food and not alcohol purchases), taxes and other factors.

Of course, though not described herein, in every instance where payment is referenced, the food vendor might be paid in other, less preferred manners. For example, a wire transfer could be effectuated to the food vendor's bank account. Alternatively, a check might be sent to the food vendor.

A particular benefit of the single use credit card number is that the food vendor can input that number into a point of sale processing system and immediately be credited with payment. For example, the voucher system 612 may transmit the single use credit card number back to the mobile communication device 608 of the food vendor. The food vendor may then input that credit card number into their point of sale processing system, thus effectuating a transfer of funds from the voucher system operator's account to the food vendor's account via a banking system.

In one embodiment, the amount of the payment from the voucher system operator to the food vendor may be less than the redemption value. For example, the voucher system operator might apply a service or transaction fee to the transaction. For example, in the first scenario described above, the amount of the redemption value to the customer is $40.00. The voucher system operator might charge a 10% transaction fee and thus transmit payment to the food vendor of $36.00. In the second scenario described above, the amount of the redemption value to the customer is $35.00. The voucher system operator might thus transmit payment to the food vendor of $31.50.

Of course, if the amount of the voucher is insufficient to pay the customer's entire bill, the food vendor preferably requires that the customer supplement the voucher credit with one or more other forms of credit to pay the bill. For example, in the first scenario described above where the bill total was $52.00 and the voucher has a value of $40.00, the customer may be required to pay the $12.00 difference via another form of payment such as cash, check, credit card or the like.

Of course, the above-described steps may be performed in other orders than specifically described. For example, in one embodiment of the invention the vendor may transmit voucher information for verification and only if the voucher is verified may the vendor then be required to transmit bill information such as an image of a receipt and an amount of the bill. In other embodiments, the vendor might be required to provide voucher information, receipt information and bill information and then transmit all of that information to the voucher provider.

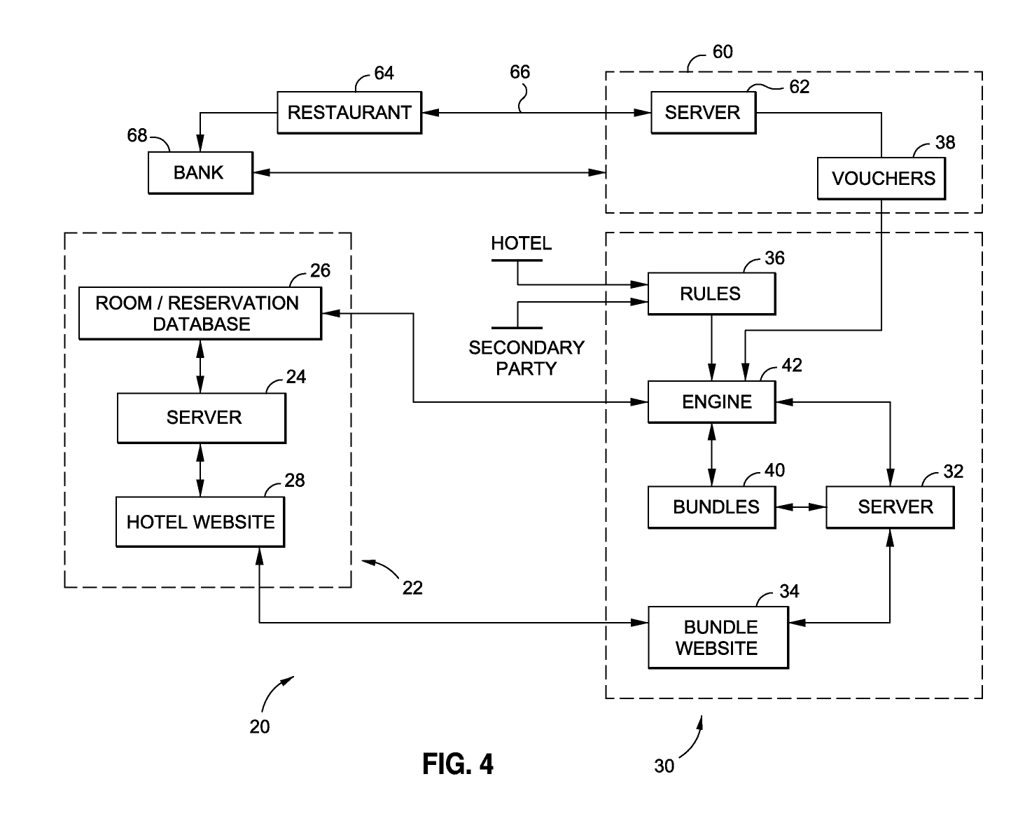

FIG. 4 illustrates one particular embodiment of the system 20 of the invention with a voucher redemption feature. As illustrated, in this embodiment a voucher provider 60 generates vouchers. The vouchers might be generated, for example, by a server 62 or other computing device or system. Information regarding the individual vouchers may be stored in the voucher database 38. As indicated above relative to the bundling feature of the invention, the voucher information from the voucher database 38 may be used by a bundling engine 42 to generate one or more bundles.

As indicated above, a voucher may be presented for redemption at a vendor 64, such as a restaurant. Information may be exchanged between the vendor 64 and the voucher provider 60, such as via one or more communication links 66. As indicated above, such information may comprise information which identifies one or more vouchers, voucher status, etc.

As further illustrated, the voucher provider 60 may communicate with a bank 68 or other financial entity. For example, upon approving redemption of a voucher, the voucher provider 60 may transmit instructions to the bank 68 to effect payment from the voucher provider's account to a single use credit card or similar account at the bank 68. The vendor 64 may communicate the single use credit card number to the bank 68 to effectuate transfer of the funds from the associated account to the food vendor's account.

In a preferred embodiment the vendor is paid by providing the vendor with a single use credit card number which is associated with an account with which the payment funds are associated. In such a situation a single use credit card number may be provided for each and every individual voucher redemption transaction payment. However, in other embodiments the vendor might be provided with a single use credit card number each day, week or other period, which credit card number corresponds to an account which has payment for all voucher transactions processed during a period of time.

As indicated above, it is also possible, though not preferred, to pay the vendor in other fashions. For example, the voucher provider might pay the vendor by wire transfer upon approval of each voucher payment.

Of course, the system 20 might have other configurations. In one embodiment, for example, the voucher redemption system need not include the bundling features. For example, in one embodiment of the invention the system may comprise only the voucher provider 60 and associated components/features and need not include the bundling features. In such an arrangement a voucher provider may generate and issue vouchers in various forms (including other than in bundled form and by other than reservations for lodging), which vouchers may be redeemed at one or more third party providers such as food vendors. In such an embodiment, the voucher provider 60 might, for example, operate one or more websites or other systems by which users may request, configure or select vouchers (including by selecting voucher options or criteria and/or custom-defining one or more voucher options or criteria). In other embodiments, such a website might offer a user the choice to obtain one or more vouchers or select one or more bundles.

As one example, a voucher provider might generate stand-alone food vouchers. For example, Company A may be sending 100 employees to a one-day conference located near Company A's office. As a result, the 100 employees may not require any lodging. However, Company A may wish to provide each of the employees with lunch. As one option, Company A might purchase 100 $25.00 food vouchers which the employees could use to pay for lunch at one or more food vendors. As described herein, a particular advantage of such a configuration is that it allows Company A to control the costs/expenses associated with their employees. In particular, by this mechanism, Company A does not have to provide credit cards or cash, does not have to provide reimbursements, and can be assured that the funds that were expended to provide the employees with food were in fact used for that purpose.

It will also be appreciated that the various portions of the system may be operated by the same or different entities. For example, in the example illustrated in FIG. 4, the lodging provider, bundling system operator and voucher provider may comprise separate entities. However, the voucher provider might also operate the bundling system, etc. In addition, while a voucher provider might operate certain aspects of the redemption system, webservers or the like might be owned or operated by contractors or the like.

It will be appreciated that the method and system has applicability to a food service system such as described in the above-referenced U.S. patent application Ser. No. 11/082,450, filed Mar. 17, 2005. In particular, in one embodiment the voucher provider may issue vouchers which can be used to obtain in-room meal service directly through or via the voucher provider, or those same vouchers might be presentable to one or more third parties. For example, a customer might obtain a bundled lodging and food voucher package. While the customer is staying at the hotel, the customer might present the voucher to the voucher provider, Order Inn, and thus obtain in-room meal service. As indicated in the above-referenced application, the customer might call Order Inn and place a food order with Order Inn, using the food voucher as payment. Order Inn may thus have food delivered to the customer at their hotel via one or more food providers.

However, that customer may also wish to eat at a restaurant which is located close to their hotel. The customer may thus travel to the restaurant, obtain food and then pay for some or all of the food using the voucher.

In one embodiment, vouchers may have various restrictions or conditions of use. For example, a voucher may only be usable at certain authorized food vendors. For example, the voucher provider may select one or more food vendors based upon various criteria. These criteria may include, but are not limited to: a) location; b) the food vendor does not provide delivery service; c) brand; d) food quality; e) food type (Italian, Mexican, American, Asian or other types of cuisine); f) reputation; g) price; h) customer demand; and i) hours. In one embodiment, the voucher provider may enter into a service contract with the food vendor. The food vendor preferably agrees to pay a commission or transaction fee in exchange for the voucher provider driving traffic/customers to them. As indicated above, for example, the transaction fee might be 10%. The voucher provider might educate the food vendor regarding the method and system, including how to redeem vouchers. In one embodiment, the food vendor may be provided or download a voucher redemption application.

In one embodiment, when a voucher is issued it may designate one or more food vendors at which the voucher may be used or redeemed. For example, relative to lodging and food voucher bundles, the voucher provider might identify the one or more food vendors which are located in close proximity to the lodging provider or in close proximity to the employee (such as close to an employee jobsite, etc.). Those food vendors may be identified on the voucher, such as by printing the names of the vendors, their location, contact information or the like. Similarly, a company might contract with the voucher provider for vouchers which are usable only in a certain location. In the event that a voucher is designated for use at a particular location or at a specific vendor, that information may be associated with the voucher in the voucher database. Thus, when the voucher is presented for redemption, the voucher system may confirm that the voucher is being presented at an authorized or designated location for that specific voucher. Again, a particular advantage of such a feature is customer control: the customer, such as employer, can ensure that funds which are being allocated for a particular purpose (such as to provide food for their employees) is used for that purpose.

In one embodiment, accounts may be provided corresponding to each vendor or other goods or services provider at which a voucher may be presented. The account may be associated with the voucher system. The account may be used to track and store information regarding presented vouchers, the amounts of customer bills and voucher credits, payments to the vendor and the like. In one embodiment, a vendor may be permitted to access their account to obtain associated information. For example, the voucher provider may operate a website. The vendor may use access information to contact a server and access the site and their associated account. Via such a website the vendor might be presented with a variety of voucher-related information. For example, a vendor might see all vouchers which were presented on a particular day, the amount of the customer's total bill, information regarding the associated bill (such as an image of the vendor's customer receipt), the redemption amount to the customer and then the amount payable to the vendor. The vendor may also be able to review the credit card number or other payment information, including whether payment has been completed.

In one embodiment, a customer might be permitted to indicate or select voucher criteria. First, a customer might make a selection of where a voucher may be used, such as from a list of vendors or a geographic area. For example, a customer might be provided with a drop-down menu at a website, which menu indicates the names of certain vendors (restaurant chain A, restaurant chain B, etc) or locations (Las Vegas, Nev.; Los Angeles, Calif.; Lubbock, Tex., etc.) A customer might also be permitted to select a time or duration that the voucher is usable, such a specific date range or a time period such as 1 week, 1 month or 1 year from issuance).

While vouchers of the invention may be used by companies to control “per diem” costs, the vouchers may be used as gift certificates or to satisfy other needs. For example, a grandparent may wish to give a voucher to their grandchild as a gift. The grandparent might, for example, designate that the voucher is only redeemable at a particular vendor (such any Best Buy electronics store) and that the voucher is only redeemable for 1 year. In this manner, the grandparent can be assured that the grandchild utilizes the voucher for a desired purpose (rather than, for example, cash which the grandchild might use for any purpose) and so that if the voucher is not used, the grandparent can get the funds back so they are not wasted (as indicated herein, as one option, a voucher purchaser might select an option which allows any unused funds (“breakage”) to be refunded).

One advantage to the invention is that a customer may utilize a single source (such as a single voucher provider's website) to obtain vouchers for a variety of different third parties or having a variety of different criteria. For example, via a single website, a customer might be able to purchase a voucher which is good at any one of a number of vendors or more than one vendor. For example, a customer might, via a single website or other single voucher source, be able to select a voucher which is redeemable at Best Buy, Sears, JcPenny, Macy's, Walmart and/or a variety of other retailers, rather than purchasing items or gift cards directly from those specific vendors. Also, the customer might seek a voucher which is redeemable at combinations of vendors, rather than just one vendor.

As described herein, vouchers might be redeemable at different vendors and for different goods or services (not just food, but transportation, clothing and other goods, etc.) Also, it will be appreciated that the party who purchases or obtains a voucher does not have to be the same party who redeems the voucher.

The method and system may have other configurations than as just described above. As one variation, a vendor may either not have a mobile communication device or may not wish to use a mobile communication device as the interface with the voucher system. In such a configuration, the vendor may simply access a website which is supported by the voucher system, such as by logging onto the website and accessing their account via a computing device. Such a computing device might comprise a laptop or desk top computer.

In such a configuration, when a customer presents a voucher, the vendor preferably obtains information regarding the voucher and enters that information. If the computing device has an information reader, the information may be machine-read from the voucher. Otherwise, the vendor may enter the information manually, such as by entering a voucher serial number printed on the voucher via a keypad of the computing device. Also, while the vendor may provide a picture or other image of the customer's receipt (such as by either capturing the image via an image capture device associated with the computer or by using a camera and then transferring or uploading the image to the computing device), the vendor may simply be prompted to input information regarding the receipt, such as the receipt number (or other identifier which identifies that receipt from other receipts of that food vendor and thus can be used to audit the receipt at a later point, such as to confirm what goods or services were purchased and their price). One particular advantage to providing an image of the receipt is that an employer might audit the receipts of their employees to ensure that the vouchers are being used for authorized purchases. For example, a company may indicate that purchases of food, but not liquor, are authorized. Because a food vendor might also supply liquor, the ability of the company to view the receipts which are associated with used vouchers enables the company to determine whether employees have violated policy and purchased liquor with the vouchers.

In other respects the method may be substantially the same. Once the voucher is confirmed and credited, payment information may be provided to the vendor. As indicted, this may be provided by a message, such as transmitted from the voucher system website to the vendor, or via posting to the vendor's account.

In another configuration, a vendor may validate a voucher simply via a telephone call. In such a configuration, upon presentation of a voucher by a customer, the vendor may place a telephone call to a call center operated (directly or indirectly) by the voucher provider. The vendor may provide voucher information (such as the voucher serial number), receipt information (such as the food vendor's receipt number) and the amount of the bill to the voucher provider over the phone (such as to a live operator or a computer automated system). The voucher provider may then verify the voucher, calculate total amount owing (i.e. the amount of the bill plus a gratuity), and determine the amount of the voucher credit. The voucher provider also preferably then effects payment to the vendor. For example, a call center operator of the voucher provider may access the voucher system via a workstation. Upon entering the voucher information from the vendor in association with the vendor's account, the system may display the single use credit card number to the operator. The operator may then provide that number over the phone to the vendor for their use in effecting payment. In other variations, the voucher provider might send a written report to the food vendor, such as via mail or fax. This report might include information regarding presented vouchers, bill amounts, transaction fees, payments to the vendor and associated single use credit card or other payment information.

The above-described methods have the advantage that the validity of the voucher is determined upon presentation. This is particularly important in the situation where the customer is permitted to present the voucher at more than one location. For example, a customer might attempt to utilize the voucher to pay for food ordered through the voucher provider for in-room delivery and then quickly travel to a restaurant and attempt to present the same voucher as payment for food services at the restaurant. In accordance with the above-described methods, the voucher is validated before it is accepted as payment by the customer. Thus, for example, if the customer has presented the voucher to the voucher provider for in-room food delivery, the voucher provider immediately updates the voucher database to indicate that the voucher is redeemed. Thus, if the customer then attempts to re-present the voucher at a restaurant, upon validation the voucher will be rejected.

In another embodiment of the invention, voucher presentation is simplified, but without the same level of control as the methods described above. In particular, in one embodiment of the invention when a voucher is created, a single use credit card number or other payment information is associated with the voucher. Preferably, the single use credit card number or other payment information (such as debit card, gift card, multiple use credit card, EFT or other information) is associated with an account having associated value or funds, such as a value account of a financial institution, such as a bank. Most preferably, the voucher and the associated financial account have use limitations. In a preferred embodiment, the use limitations limit use of or redemption of the vouch at specific locations.

Upon presentation of the voucher to a vendor, the vendor utilizes the single use credit card number to effectuate payment to themselves. For example, the vendor may enter the single use credit card number into a point of sale terminal as payment against a food services bill.

Preferably, when the vendor utilizes the single use credit card number, the financial institution checks that the vendor is an authorized redemption location. If not, the transfer is prohibited.

As one example, Company A may seek to provide food vouchers for 10 employees who are attending an all day conference. Company A wishes to ensure that the employees use the vouchers for food and not for other goods or services, such as to purchase personal items or the like. Company A may thus obtain vouchers from a voucher provider, which vouchers have single use credit card numbers which are usable only at Food Vendor 1, Food Vendor 2 and Food Vendor 3 in the vicinity of the conference. Preferably, this limitation upon use is transmitted from the voucher provider to the financial institution and is associated with the credit card accounts. The vouchers are preferably issued with a notification of the locations at which the voucher may be presented.

If one of the employees seeks to present the voucher as payment at Sporting Goods Vendor A, the voucher payment will be rejected. In particular, when Sporting Goods Vendor A inputs the single use credit card number into their point of sale terminal and seeks payment, the vendor's identification will not match the three permitted vendor locations and the financial institution will reject payment. On the other hand, if the employees seek to present the voucher to Food Vendors 1, 2 or 3, the single use credit card numbers will be useable and payment will be effected to those vendors.

As another example where the voucher is associated with a financial account other than a single use credit card or account, Company A might obtain a $100 limited use voucher from a voucher provider. This voucher might have associated financial account information which has limitations which permit the voucher to be used more than once (such as having the form of a debit card), but still only at specific locations or for particular goods or services. Thus, for example, an employee might use the voucher to pay for breakfast, then lunch and then dinner (up to the maximum total voucher value of $100) at an authorized food vendor, such as Food Vendor 1.

This method and system of the invention has the benefit that the voucher does not need to be validated by the vendor. In addition, the voucher has use controls which limit use of the voucher.

As another aspect of the voucher system, various business models may be employed in issuing and redeeming the vouchers. For example, in one embodiment a customer may obtain a voucher from a voucher provider for a price. If the customer does not use the entire value of the voucher then in one configuration, the voucher provider may keep the “breakage” (i.e. the difference in the amount paid for the voucher vs. the amount used). As one example, a customer might pay $40 to a voucher provider for a $40 voucher. The customer may obtain $35 in food services from an authorized food vendor. In this scenario, the voucher provider may keep the $5 in unused voucher funds.

In another configuration, a customer may be refunded all or a portion of any breakage. For example, in the above-referenced example, if the customer had $5 in unused voucher funds, the voucher provider could refund the $5 in unused funds, such as at the expiration of the voucher. In such a configuration, the voucher provider might charge the customer a transaction or service fee. For example, the voucher provider might charge the customer a per voucher transaction fee or a fee based upon the value of vouchers purchased over time. For example, the voucher provider might charge a set fee amount of $5.00 per voucher or a percentage of the value of each purchased voucher. Alternatively, the voucher provider might charge a fee for all vouchers purchased during a period of time, such as $X per day or week.

In yet another configuration, the voucher provider might keep the breakage but provide rewards to the customer based upon the amount of unused funds. As one example, the voucher provider might generate a customer account corresponding to each voucher customer. In one configuration, the customer might comprise the individual employee of a company. The voucher provider might post a reward equivalent to a percentage of any unused voucher funds for that customer.

As one example, Company A might purchase a $40 voucher for employee A and a $50 voucher for employee B. The voucher provider issues the vouchers and generates an account for each of employee A and B. The voucher provider may offer a 10% rewards program relative to those accounts. Thus, assuming that employee A only uses $30 of the $40 value of the voucher, the voucher provider might place 10% of the unused funds ($10), or $1, into employee A's account. Likewise, assuming that employee B only used $20 of the $50 in voucher funds, the voucher provider might place $3 in employee B's account.

In one embodiment, the customer may use the rewards which are associated with their account, such as to obtain a voucher, purchase a bundle (such as a lodging/voucher bundle) or the like. For example, over time a customer may accrue $50 in their account. The customer might redeem that $50 for a $50 voucher which the customer can use to obtain food from a food vendor.

In various embodiments, additional business features may be associated with these options. For example, as indicated above, a voucher provider might require a food vendor to accept a transaction fee for each voucher use. As indicated above, such a fee might comprise 10 or 15% of the value of the payment. In addition, in cases where the voucher provider effectuates a payment to the vendor, the voucher provider might require that the vendor pay for any credit card processing or transaction fees. Lastly, in cases of bundles, the voucher provider might also charge a transaction or processing fee to the primary goods and services provider, such as a 10% or 15% transaction fee to a lodging provider.

As one example, the voucher provider might bundle a $70 room reservation and $30 meal voucher and sell that bundle to a customer for $100. The voucher provider might charge a 10% reservation fee to the lodging provider (e.g. retain $7 of the $100), may collect a 10% transaction fee from the food vendor where the voucher is used, and may keep any breakage between the amount of the voucher used and the value of the voucher (for example, if the customer uses $20 of the voucher, the voucher provider would keep the $10 breakage and also charge a $2 transaction fee to the food vendor). In addition, the voucher provider might charge (or deduct from payment to) the food vendor any credit card processing fees associated with payment to the vendor.

As another example, the voucher provider might offer the same bundle but return any voucher breakage to the customer. In that event, the voucher provider may charge a 10% reservation fee to the lodging provider, may collect a 10% transaction fee from the food vendor, may collect a voucher transaction fee from the customer, and may charge (or deduct from payment to) the food vendor any credit card processing fees associated with payment to the vendor.

Other Aspects of the Invention

As indicated herein, a voucher preferably has associated value and identifying information. In a preferred embodiment, the voucher is preferably printed media which bears identifying information, such as a code which identifies the voucher and its associated value. As indicated, a particular advantage of printed vouchers is that information regarding the voucher can be transmitted electronically to a user/customer, thus permitting the voucher to be issued remotely to a customer. However, as indicated, the voucher might comprise other types of media, such as cards or the like. In such variations, the voucher might include a magnetic stripe, RFID tag or other mechanisms for storing information. In addition, such variations, it may be necessary to physically issue, dispense or send the voucher to the customer.

As indicated herein, the various goods and/or services to which the invention applies may vary. As indicated, a voucher may be issued which can be used to purchase or obtain any number of goods or services, such as food, travel, lodging or the like. In addition, bundles may be created from a variety of primary and secondary goods and/or services, including bundles of more than just one primary and one secondary good or service.

### Advantages of the Invention

A particular advantage of the invention is the ability of a party to offer bundles or combinations of at least one primary good/service with at least one secondary good/service, and particularly in the situation where the primary and secondary goods/services are provided by different entities. As one particular example, as noted above, many lodging providers do not have food service facilities. The lodging providers are at a disadvantage relative to “full service” lodging providers which do have food service capability, such as via an onsite restaurant. The limited service providers may thus work with a third party food service provider to bundle their lodging services with the food services offered by other parties. In this manner, a potential customer can reserve or purchase a bundle which offers them both lodging and food services.

A particular advantage of the invention is that the premium services system can be operated by a third party other than the primary service provider, such as the lodging provider. In this manner, the lodging provider does not need to entirely modify their existing customer reservation system to try and implement additional functionality. Instead, a third party can operate the premium services system 30 and can generate and offer the bundles while only needing to access existing information in the lodging provider's CRS database 26.

In this regard, the system 30 has particular applicability to other primary goods or services which are associated with a primary entity's reservation website. For example, the system 30 might connect to a car rental company's car reservation website and be used to bundle gasoline vouchers (such as from a petroleum company) with the car reservations.

Another advantage of the invention is that via the bundling, a customer may be offered a combination of at least one primary good or service with at least one secondary good or service as a package. In one embodiment, the bundle is offered at a single unified price rather than the customer having to separately purchase the goods or services from the separate providers of the primary goods and services. Preferably, the unified price can be presented at a discount as compared to the sum of the prices of the goods or services if they were to be obtained separately.

One particular advantage of the invention is that the bundling can be used to generate new and unique marketing opportunities. For example, as indicated above, a hotel which does not have on-site food service may now offer a customer a bundle of their lodging with a food service, thus making them competitive to full service lodging providers. In addition, different bundles might be created to generate different marketing opportunities. For example, a hotel in Miami might not offer a room and food bundle during winter months when demand for rooms is very high. However, in the summer when demand is lower, that hotel might offer a room and high value food voucher in order to attract guests.

As indicated, one advantage of the invention is that the bundle may be offered at a unified price which is less than the combine price of the two goods or services if they were purchased separately. For example, a hotel might normally offer a particular room at $100 per night but might offer a bundle of the room and a $20 food voucher at $100 so as to attract more customers. Of course, where the bundle is generated by a third party, various types of splits, commissions or the like might be applied. For example, a premium services provider might offer food vouchers which are useable at designated locations. Hotels which do not offer food services may allow the premium services provider to bundle their rooms/reservations with food vouchers in order to drive more guests to their hotel. In such event, the hotel might discount their room price so that when the premium services provider bundles the food voucher, the price of the bundle is less than the separate prices of the room and voucher. In other embodiments, some or part of the discounted price may be absorbed by the premium services provider. For example, in the case of a food voucher, some purchasers of vouchers may not use them and thus the premium service provider may bundle food vouchers at a discount knowing that profit will be realized do to the fact some vouchers are not used or the entire value of some vouchers are not used (for example, a hotel room may be offered at $90 normally and the premium service provider may offer a bundle of the room and a $20 food voucher at a price of $100; in that case the premium services provider might either ask the hotel to provide the room at $80 per night or the voucher provider might instead provide the $20 voucher at a paid cost of $10 by the customer).

The invention has particular advantages to customers. For example, many businesses require that their employees travel and thus need to provide their employees with food and lodging. As indicated, some hotels do not have food service. Thus, the employer may need to separately find a way to provide food services to their travelling employees. One way is to have the employee pay for food and then reimburse them. Some employees, however, baulk at having to pay out of pocket. Also, this system requires that the employer check reimbursement requests, receipts and the like for valid payment, all of which is time consuming and cumbersome. Alternatively, the employer might provide the employee with a credit card. However, in that event the employer might use the card to purchase items other than food.

In accordance with the invention, a company can reserve rooms and food as a bundle. First, when the food is purchased in the form of a food voucher that is redeemable or usable only via an authorized food supplier, the employee can only use the food voucher for the redemption of food. Second, bundling of the voucher eliminates the need for the employer to separately issue a credit card or reimburse the employee. Instead, the employer only needs to provide the voucher or the voucher code to the employee.

In accordance with the invention a company might also obtain vouchers separate from a bundle. The company might disburse these vouchers to employees to be used to pay for goods and services. Again, the vouchers have the benefit that the company is not required to provide the employees with cash, a credit card or the like.

A particular advantage of the vouchers is that, unlike cash or a credit card, the voucher has use controls or limitations. For example, a voucher may only be usable to pay for food at a designated location. In the case of cash or a credit card, an employee might use the cash or credit card to purchase personal items or other unauthorized goods or services. On the other hand, the voucher can only be used for the goods or services specified by the company.

In addition, using vouchers as a means for paying for goods and services, a company can control costs. In particular, a company can pre-purchase vouchers, thus knowing the maximum amount of the expenditure associated with the goods and services. This contrasts, for example, with a credit card where the employee may travel and use their card to make various purchases which far exceed the budget set by the company. In addition, in some embodiments of the invention, a company may arrange to recover the “breakage” or the unspent portion of the vouchers which it paid for.

Using the system, such a company may also be provided with voucher reports that enable the company to track which vouchers were redeemed, partially redeemed or not used. This helps the company audit when vouchers are necessary, the best voucher price-point/value and the like.

Using the system, a company/customer may implement various criteria or controls relating to the vouchers, thus enabling the company/customer to have complete control over the use of funds. For example, a company/customer may dictate various rules or restrictions upon the vouchers. These rules or restrictions may be associated with the vouchers to control how the vouchers are created, their features, redemption options and the like. For example, tax deductible limitations for meals and similar limitations when employees are traveling internationally. These rules or limitations vary between from country to country. Therefore, companies desire to only fund employee expenses up to these particular maximum limits to avoid added accounting and taxes consequences. A company may seek to ensure that vouchers are generated for particular jurisdictions throughout the US and international markets so that the value of the vouchers for each jurisdiction does not exceed the maximum allowed value. For example, such amount might comprise $50 for country A and $100 for country B. In the past, a company had no way to control an employee's use of cash or a credit card. Thus, the employee might travel to country A and spend $75. When the company went to reimburse the employee, accounting and tax issues would arise. On the other hand, in accordance with the invention, the company can pre-control such issues by issuing vouchers which comply with the jurisdictional limits. Customers can also include various other controls or criteria, such as maximum gratuity amounts (such as to limit employees from granting high gratuities and receiving kick-backs or the like, such as where an employee might purchase $20 in food and issue a $80 gratuity and seek use of a $100 voucher, then splitting the gratuity with the food server and thus pocketing $40).

While the vouchers have particular advantages to their users, the voucher redemption system also ensures ease of use and security to the vendors, thus facilitating acceptance of the vouchers. For example, in the past lodging providers might offer coupons to their customers, which coupons could be used for a free breakfast at an unaffiliated restaurant. First, there was a risk that customers would make unauthorized copies of the coupons. Second, in order to get paid, the restaurant would collect the coupons and then have to present the coupons back to the lodging provider in order to seek payment. The lodging provider might not pay the restaurant for some period of time or might dispute payment. In accordance with the present invention, a voucher is validated at the time it is presented. If the voucher is not validated, the customer is required to pay the restaurant directly. In addition, payment for the voucher credit is made to the restaurant immediately at the time of the transaction, preferably via use of a credit card or similar mechanism. This allows the restaurant to immediately be paid, rather than having to submit payment and wait for payment.

As indicated herein, the system and method are applicable to other types of goods and services. Thus, various of these types of advantages or other advantages may be realized as a result of bundling of other types of goods and services. Likewise, value vouchers might be provided which are available to be used to pay for a wide range of goods or services at various different goods or services vendors.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of issuing and redeeming a value voucher comprising the steps of:
issuing a value voucher, said value voucher having an associated voucher value, voucher terms of use, and voucher identification information;
receiving voucher identification information regarding said value voucher from a vendor to which said value voucher was presented by a customer;
determining a redemption amount based upon a bill owing said customer to said vendor;
validating said value voucher for said redemption amount;
wherein if said voucher is invalid, transmitting a rejection to said vendor; and
wherein if voucher is valid, transmitting information to said vendor regarding a voucher credit against said bill, said voucher credit comprising the lesser of the voucher value or the redemption amount and transmitting payment to said vendor for said voucher.

2. The method in accordance with claim 1 wherein said voucher identification information comprises a machine-readable code.

3. The method in accordance with claim 1 wherein said step of transmitting payment comprises transmitting a single use credit card number to said vendor, said single use credit card number corresponding to a financial institution account having payment funds associated therewith.

4. The method in accordance with claim 1 wherein said redemption amount comprises an amount of a bill plus a gratuity.

5. The method in accordance with claim 1 wherein said step of transmitting payment comprises transmitting funds by wire transfer to an account associated with said vendor.

6. The method in accordance with claim 1 wherein said terms of use are selected from the group consisting of: one or more approved locations of use and time of use.

7. The method in accordance with claim 1 wherein said value voucher is redeemable for food at an approved food provider.

8. The method in accordance with claim 1 further comprising the step of receiving information regarding said bill from said vendor.

9. The method in accordance with claim 8 wherein said information comprises an image of said bill.

10. The method in accordance with claim 1 wherein said step of receiving voucher identification information comprises receiving a phone call over which said information is provided by said vendor.

11. The method in accordance with claim 1 wherein said step of receiving voucher identification information comprises receiving a scanned bar code.

12. A computer-implement voucher generation and redemption system comprising:
at least one computing device having at least one processor configured to execute machine readable code stored in a tangible medium configured to:
generate a value voucher having an associated voucher value, voucher terms of use, and voucher identification information;
transmit information regarding a purchased value voucher to a use, said information including at least said voucher identification information;
receiving a request from a vendor at which said value voucher has been presented by said user for redemption against a bill to validate said voucher;
validating said value voucher;
wherein if said voucher is invalid, transmitting a rejection to said vendor; and
wherein if voucher is valid, transmitting information to said vendor regarding a voucher credit against said bill, said voucher credit comprising the lesser of the voucher value or the redemption amount and transmitting payment to said vendor for said voucher.

13. The system in accordance with claim 12 wherein said voucher identification information comprises a machine-readable code.

14. The system in accordance with claim 12 wherein said transmitting payment comprises transmitting a single use credit card number to said vendor, said single use credit card number corresponding to a financial institution account having payment funds associated therewith.

15. The system in accordance with claim 12 wherein said redemption amount comprises an amount of a bill plus a gratuity.

16. The system in accordance with claim 12 wherein said terms of use are selected from the group consisting of: one or more approved locations of use and time of use.

17. The system in accordance with claim 12 wherein said value voucher is redeemable for food at an approved food provider.

18. The system in accordance with claim 12 further comprising receiving information regarding said bill from said vendor.

19. The system in accordance with claim 18 wherein said information comprises an image of said bill.

20. The system in accordance with claim 12 wherein said receiving a request comprises receiving a scanned bar code.
